(19) United States
(12) Patent Application Publication
(10) Pub. No.: US 2026/0273714 A1
(43) Pub. Date: Sep. 17, 2026

(54) POWER TOOL INCLUDING A COLD-START OPERATION

(71) Applicant: MILWAUKEE ELECTRIC TOOL CORPORATION, Brookfield, WI (US)

(72) Inventors: Joseph W. Miller, Waukesha, WI (US); Evan M. Glanzer, Milwaukee, WI (US); Katie M. Cameron, Milwaukee, WI (US); Patrick D. Gallagher, New Berlin, WI (US)

(21) Appl. No.: 19/563,424

(22) Filed: Mar. 11, 2026

Related U.S. Application Data
(60) Provisional application No. 63/769,875, filed on Mar. 11, 2025.
(60) Provisional application No. 63/825,118, filed on Jun. 17, 2025.

(51) Int. Cl. B25D 11/06

(52) U.S. Cl. CPC B25D 11/06

(57) ABSTRACT

Breakers and related power tools with a cold-start feature and methods for controlling the same. A breaker comprising a housing, a motor within the housing, and an electronic controller. The electronic controller is electronically connected to the motor. The electronic controller is configured to initiate a first start-up operation (e.g., a normal start) of the motor by increasing a speed of the motor according to a first start-up profile, the first start-up profile defining a start-up rate of the motor for reaching an ending speed over a first time period. The electronic controller is further configured to detect an overcurrent event during the first start-up operation, and in response to detecting the overcurrent event, initiate a second start-up operation (e.g., cold start) of the motor according to a second start-up profile, the second start-up profile different from the first start-up profile.

### RELATED APPLICATIONS

This application claims priority to U.S. Provisional Application No. 63/769,875, filed Mar. 11, 2025, and U.S. Provisional Application No. 63/825,118, filed Jun. 17, 2025, the entire contents of which are incorporated herein by reference.

### FIELD

The present disclosure relates to cold-start operations for a power tool.

### SUMMARY

Power tools include a soft start at startup that ramps up the speed regardless of the speed selection to avoid an in-rush current from the power source affecting initial operation. In addition to soft start, a load-based speed control is also performed in some power tools to improve user experience, reduce vibrations, reduce noise, or the like. Load-based speed control includes detecting whether the tool is in a loaded state or an unloaded state. A loaded state is when the output tool bit of the power tool is in contact with a workpiece (e.g., fastener, wood, metal, floor, wall, etc.) and/or is performing an action (e.g., fasten, drill, drive, cut, etc.) on the workpiece. An unloaded state is when the output tool bit is not in contact with or not performing an action on the workpiece. The loaded state and the unloaded state may be different for different power tools.

Power tools include controllers that determine whether the power tool is loaded or unloaded. Typically, the controller receives a measurement of a parameter (e.g., current, speed, vibrations, noise, etc.) that is affected by the load from a sensor and the controller compares the parameter to a threshold to determine whether the power tool is in the loaded state or an unloaded state. For example, current, vibrations, and noise may increase, and the speed may decrease during the transitions from an unloaded state to a loaded state. The controller typically uses a single parameter and compares an instantaneous or average measurement of this parameter to a threshold to determine the loaded state. The threshold is pre-determined and stored in a memory of the controller or the tool.

Current is the operating parameter that may more commonly be used in power tools to determine the operating state. In these power tools, instantaneous or average current is measured, or some form of variation in current is measured and compared to the stored threshold to determine whether the power tool is in the loaded state or the unloaded state. However, the current flow may be affected significantly by the temperature and/or other environmental or operating parameters. Temperature may vary significantly based on the time of use of the power tool, changes in seasons, whether the power tool is used indoors or outdoors, and other factors. When the temperature affects the current flow, the controller may have false positives and/or false negatives in determining whether the power tool is loaded. These false positives and false negatives may significantly affect the operation of the power tool (e.g., not sufficient speed to perform operation, or excessive noise). Additionally, the false positives and false negatives may also affect the user experience of operating the power tool. This may be particularly apparent in powered hammer tools that produce higher vibrations and/or noise compared to non-hammer based tools.

Accordingly, there is a need for improved load-based speed control in powered hammer tools.

In addition, power tools are used in numerous environmental conditions, including in extreme hot and cold temperatures. One drawback of a grease-lubricated power tool design, such as a percussion tool, including a breaker, is the high torque required to operate the tool at extreme cold temperatures (e.g., less than −10° C.). For a brushless motor driven system, this high torque can lead to peak currents high enough to trip a component-level overcurrent protection (i.e., a hardware overcurrent condition), which may lead to “dead trigger-pulls” where the tool initiates a normal start-up operation but fails to reach a maximum motor speed before shutting down.

Embodiments described herein introduce a cold start-up sequence to warm up a power tool, such as, for example, a grease-lubricated system included in such a power tool, to a temperature that will allow for normal operation of the power tool. The cold-start sequence allows the power tool to be used in extreme temperature environments, such as cold environments. Some embodiments described herein implement the cold start-up sequence using a closed-loop torque control, which prevents large current spikes from tripping overcurrent protection included in the power tool.

The embodiments and techniques described herein relate to a breaker including a housing, a motor within the housing, and an electronic controller electronically connected to the motor. The electronic controller is configured to initiate a first start-up operation of the motor by increasing a speed of the motor according to a first start-up profile, the first start-up profile defining a start-up rate of the motor for reaching an ending speed over a first time period, detect an overcurrent event during the first start-up operation, and in response to detecting the overcurrent event, initiate a second start-up operation of the motor according to a second start-up profile, the second start-up profile different than the first start-up profile.

In some embodiments, the electronic controller, according to the second start-up profile, increases a speed of the motor at a linear rate over a second time period until reaching the ending speed, wherein the second time period is longer than the first time period.

In some embodiments, the electronic controller, according to the second start-up profile, increases a speed of the motor at a parabolic rate over a second time period until reaching the ending speed.

In some embodiments a second time period is longer than a first time period.

In some embodiments the electronic controller, according to the second start-up profile, increases a speed of the motor to an intermediary speed during a second time period, holds the motor speed at the intermediary speed for a third time period, and increases the speed of the motor from the intermediary speed to the ending speed during a fourth time period.

In some embodiments, the electronic controller increases the speed of the motor to the intermediary speed at a linear rate or a parabolic rate during the second time period.

In some embodiments, the electronic controller increases the speed of the motor from the intermediary speed to the ending speed at a linear rate or a parabolic rate during the fourth time period.

In some embodiments, the intermediary speed is lower than the ending speed.

In some embodiments, a total of the second time period, the third time period, and the fourth time period is longer than the first time period.

In some embodiments, the electronic controller is configured to operate the motor during the second start-up operation using a closed-loop control.

In some embodiments, the breaker further includes a power switching network, wherein the power switching network includes a high-frequency gallium nitride (GaN) switching network.

The embodiments and techniques described herein relate to a method of operating a breaker, the method including initiating a first start-up operation of a motor of the breaker by increasing a speed of the motor according to a first start-up profile, the first start-up profile defining a start-up rate for reaching an ending speed over a first time period, detecting an overcurrent event during the first start-up operation; and in response to detecting the overcurrent event, initiating a second start-up operation of the motor according to a second start-up profile that is different from the first start-up profile.

The embodiments and techniques described herein relate to a power tool including a motor and an electronic controller. The electronic controller is operably coupled to the motor and configured to initiate a first start-up operation of the motor by increasing a speed of the motor according to a first start-up profile, the first start-up profile defining a rate at which the speed of the motor is increased to reach an ending speed over a first time period, detect an overcurrent event during the first start-up operation, and in response to detecting the overcurrent event, initiate a second start-up operation of the motor according to a second start-up profile that differs from the first start-up profile.

In some embodiments, during the second start-up operation, a speed of the motor increases from a first speed at a reduced rate relative to the first start-up operation until the motor reaches the ending speed.

In some embodiments, the second start-up profile defines a start-up duration that is longer than a duration of the first start-up profile.

In some embodiments, the second start-up operation includes increasing the speed of the motor to an intermediary speed, maintaining the speed of the motor at the intermediary speed for a holding period, and thereafter increasing the speed of the motor from the intermediary speed to the ending speed.

In some embodiments, the holding period is longer than a time period required to reach the intermediary speed.

In some embodiments, the second start-up profile causes a rate of change of the speed of the motor to increase over time during the second start-up operation.

In some embodiments, the second start-up operation is initiated in response to a failure of the first start-up operation before the motor reaches the ending speed.

In some embodiments, the second start-up operation terminates when the motor reaches the ending speed without detection of an additional overcurrent event.

The embodiments and techniques described herein relate to a powered hammer tool including a housing, a motor within the housing, and an electronic controller electronically connected to the motor. The electronic controller is configured to determine a temperature of the powered hammer tool, determine an operating parameter of the powered hammer tool, determine an operating state of the powered hammer tool based on the temperature and the at least one operating parameter, the operating state indicating whether the powered hammer tool is in a loaded state or an unloaded state, drive the motor at a first speed in response to the powered hammer tool being in the loaded state, and drive the motor at a second speed in response to the powered hammer tool being in the unloaded state, wherein the first speed is greater than the second speed.

In some embodiments, the operating state is at least one selected from a group consisting of a motor speed and a motor power.

In some embodiments, the electronic controller is further configured to determine the operating state further based on an accumulated runtime of the powered hammer tool.

In some embodiments, the powered hammer tool further includes a memory configured to store a first coefficient for the at least one operating parameter, a second coefficient for the temperature, and an offset. The electronic controller is further configured to determine a linear sum of at least a product of the first coefficient and the at least one operating parameter, a product of the second coefficient and the temperature, and the offset, determine a predictor based on the linear sum, and compare the predictor to an operating state threshold, wherein the operating state is determined based on a relationship between the predictor and the operating state threshold.

In some embodiments, the electronic controller is further configured to update, using a machine learning model, the first coefficient, the second coefficient, and the offset.

In some embodiments, the temperature of the powered hammer tool is a temperature of an electronics heatsink of the powered hammer tool.

In some embodiments, the powered hammer tool further includes a temperature sensor adjacent the electronics heatsink configured to provide an indication of the temperature of the electronics heatsink, wherein the electronic controller is configured to determine the temperature using the temperature sensor.

In some embodiments, the electronic controller is further configured to increment a load state counter in response to the powered hammer tool being in a loaded state, and activate a service indicator in response to the load state counter exceeding a service threshold.

In some embodiments, the electronic controller is further configured to stop the load state counter in response to the powered hammer tool being in an unloaded state.

In some embodiments, the electronic controller is configured to receive a selection of a first mode, and drive the motor at a selected speed regardless of the operating state of the powered hammer tool in response to the selection of the first mode.

The embodiments and techniques described herein relate to a method for operating a powered hammer tool including a motor. The method includes determining, using an electronic controller of the powered hammer tool, a temperature of the powered hammer tool, determining, using the electronic controller, an operating state of the powered hammer tool based on the temperature and at least one operating parameter, the operating state indicating whether the powered hammer tool is in a loaded state or an unloaded state, driving, using the electronic controller, the motor at a first speed in response to the powered hammer tool being in the loaded state, and driving, using the electronic controller, the motor at a second speed in response to the powered hammer tool being in the unloaded state, wherein the first speed is greater than the second speed.

In some embodiments, the operating state is at least one selected from a group consisting of a motor speed and a motor power.

In some embodiments, the method further includes determining the operating state further based on an accumulated runtime of the powered hammer tool.

In some embodiments, the method further includes storing, in a memory of the powered hammer tool, a first coefficient for the at least one operating parameter, a second coefficient for the temperature, and an offset, determining a linear sum of at least a product of the first coefficient and the at least one operating parameter, a product of the second coefficient and the temperature, and the offset, determining a predictor based on the linear sum, and comparing the predictor to an operating state threshold, wherein the operating state is determined based on a relationship between the predictor and the operating state threshold.

In some embodiments, the method further includes updating, using a machine learning model, the first coefficient, the second coefficient, and the offset.

The embodiments, the method further includes providing, using a temperature sensor adjacent the electronics heatsink, an indication of the temperature of the electronics heatsink, and determining the temperature based on the indication.

In some embodiments, the techniques described herein relate to a method comprising incrementing a load state counter in response to the powered hammer tool being in a loaded state, and activating a service indicator in response to the load state counter exceeding a service threshold.

In some embodiments, the method further includes stopping the load state counter in response to the powered hammer tool being in an unloaded state.

In some embodiments, the method further includes receiving a selection of a first mode, and driving the motor at a selected speed regardless of the operating state of the powered hammer tool in response to the selection of the first mode.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather, these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on a non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1A is a side view of a percussion tool, according to some embodiments.

FIG. 1B is a top view of the percussion tool of FIG. 1A.

FIG. 1C is a front view of another embodiment of the percussion tool of FIG. 1A, according to some embodiments.

FIG. 2A is a side view of a powered hammer tool, according to some embodiments.

FIG. 2B is a side view of a battery pack for the powered hammer tool of FIG. 2A, according to some embodiments.

FIG. 3 is a block diagram of the control system of the percussion tool of FIG. 1A or the powered hammer tool of FIG. 2A, according to some embodiments.

FIG. 4 is a flowchart illustrating a method for operating the powered hammer tool of FIG. 2A, according to some embodiments.

FIG. 5 is a block diagram of tool electronics of the powered hammer tool of FIG. 2A, according to some embodiments.

FIG. 6 is a graph illustrating inputs to a machine learning model for the powered hammer tool of FIG. 2A, according to some embodiments.

FIG. 7 is a flowchart illustrating a method for operating the powered hammer tool of FIG. 2A, according to some embodiments.

FIG. 8 is a graph illustrating example variation in the motor speed and load state over time, according to some embodiments.

FIG. 9 is a flowchart illustrating a method for controlling the percussion tool of FIG. 1A or the powered hammer tool of FIG. 2A, according to some embodiments.

FIG. 10 is a graph illustrating example variation in motor speed during a cold start-up operation applying a linear ramp to a maximum operating speed, according to some embodiments.

FIG. 11 is a graph illustrating example variation in motor speed during a cold start-up operation applying a parabolic ramp to a maximum operating speed, according to some embodiments.

FIG. 12 is a graph illustrating example variation in motor speed during a cold start-up operation applying an intermediary-speed warm-up, according to some embodiments.

### DETAILED DESCRIPTION

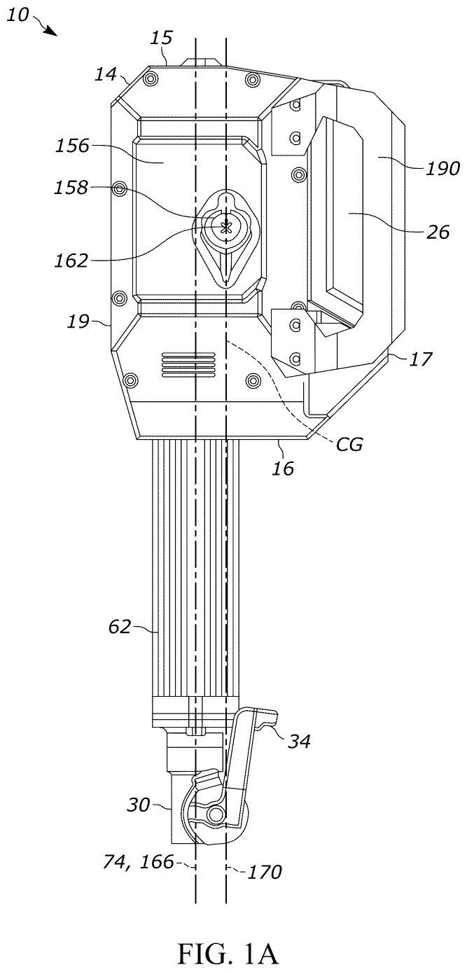

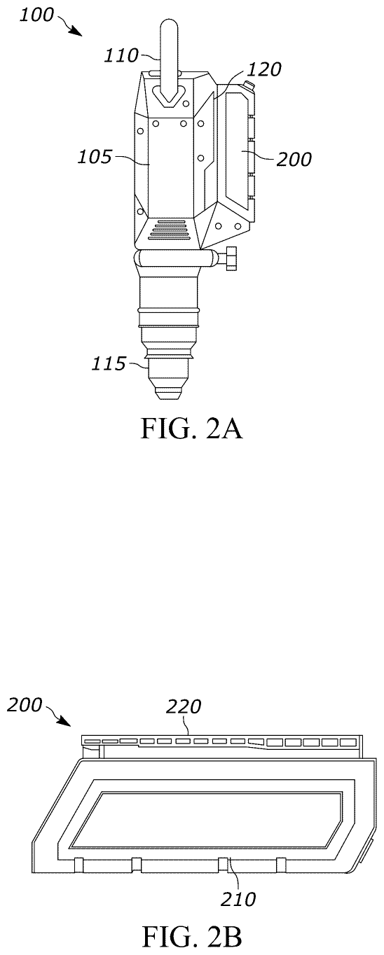

FIGS. 1A-C illustrate a percussion tool, such as a breaker 10, according to some embodiments described herein. The breaker 10 includes a housing 14, a brushless electric motor 18 supported within, for example, a crank case (not shown), and a percussion mechanism 22 driven by the motor to impart repeated percussive impacts on a surface or workpiece via a chisel 24. The housing 14 includes a top end 15, a bottom end 16, a front side 17, and a rear side 19 behind which the operator stands to operate the breaker 10. The breaker 10 includes a battery pack 26 (FIG. 1A) that is attachable to the front side 17 of the housing 14 and configured to provide electrical power to the motor 18. The battery pack 26 may include any of a number of different nominal voltages (e.g., 12V, 18V, etc.), and may be configured having any of a number of different chemistries (e.g., lithium-ion, nickel-cadmium, etc.). In the illustrated embodiment, the battery pack 26 includes a battery pack housing 468 and a plurality of individual battery cells 480 within the battery pack housing. The battery pack 26 is removable from the housing 14 for attachment to a remote charging station. As discussed in further detail below, the breaker 10 further includes a controller 300 (FIG. 3) for activating and deactivating a motor 305 (FIG. 3) in response to user input.

The chisel 24 is mounted within a tool holder 30 of the breaker 10. The tool holder 30 includes a rotatable handle 34 including a locking rod 38 within a recess 42 of the tool holder 30. When the handle 34 is rotated to an operating position, the locking rod 38 moves to a position to engage a longitudinal groove of the chisel 24 to prevent the chisel 24 from falling out when the tool holder 30 is oriented downwardly.

As shown in FIGS. 1A-C, the housing 14 includes opposite first and second sides 156, 157 that extend between the front and rear sides 17, 19. The breaker 10 includes opposite first and second operating handles 158, 160 respectively extending from the first and second lateral sides 156, 157 and together defining a second, handle axis 162. One of the first and second operating handles 158, 160 includes a trigger (not shown) that operates similar to a trigger 320 with respect to FIG. 3. The striker axis 74 is contained within a first, striker plane 166 and the handle axis 162 is contained within a second, handle plane 170 that is parallel with the striker plane 166. The striker plane 166 and the battery pack 26 are on opposite sides of the handle plane 170. The handle plane 170 intersects a center of gravity (CG) of the breaker 10, which is forward of the striker plane 166 yet rearward of the battery pack 26 because the battery pack 26 is coupled to the front side 17 of the housing 14. Thus, when an operator picks up the breaker 10 via the first and second handles 158, 160, the cylinder 62 and chisel 24 point straight downward, such that the striker axis 74 can be maintained perpendicular to the ground without the breaker 10 exerting a moment about its center of gravity (CG) that must otherwise be counteracted by the operator.

In other embodiments (not shown), the battery pack 26 may be coupled to the rear side 19 of the housing 14, and the first and second handles 158, 160 are accordingly arranged rearward of the striker plane 166, such that the handle plane 170 intersects the center of gravity (CG), which is also rearward of the striker plane 166. In other embodiments (not shown), the battery pack 26 may be coupled to the top end 15 of the housing 14 (opposite the cylinder 62) and depending on whether the battery pack 26 adds more weight forward of or rearward of the striker plane 166, the first and second handles 158, 160 and the handle plane 170 may be offset from the striker plane 166 accordingly.

As shown in FIGS. 1A-C, a breaker 10 also includes a guard 174 coupled to the housing 14 and at least partially surrounding a battery pack 26, thereby shielding the surrounded portion of the battery pack 26 from an external impact. As shown in FIG. 1B, when the battery pack 26 is coupled to a front side 17 of the housing 14, the battery pack 26 extends a first distance 178 from a surface 182 on the front side 17 of the housing 14. As also shown in FIG. 1B, the guard 174 includes a first guard member 186 and a second guard member 190 that both extend a second distance 194 from the surface 182. The first and second guard members 186, 190 are arranged on opposite sides of the battery pack 26 when the battery pack 26 is coupled to the front side 17 of the housing 14.

As shown in FIGS. 1B-C, a cross member 198 extends between the first and second guard members 186, 190. In the embodiments shown in FIG. 1B, the cross member 198 is a solid plate 202. However, in another embodiment shown in FIG. 1C, the cross member 198 can be one or more bars 206. In still other embodiments, there is no cross member between the first and second guard members 186, 190. In other embodiments, the first and second guard members 186, 190 may be solid without an internal space defined therein.

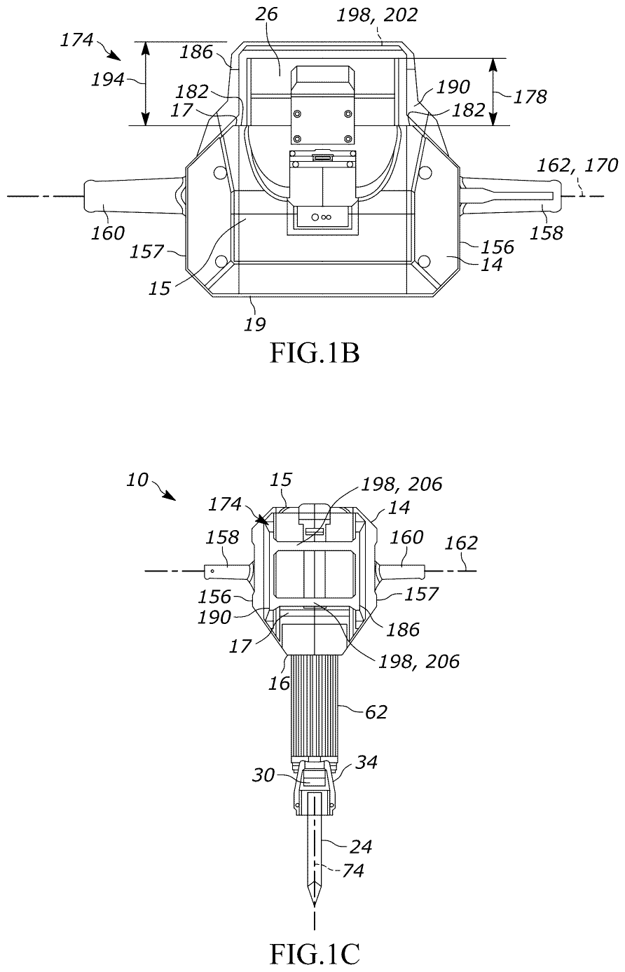

FIG. 2A illustrates an example embodiment of a powered hammer tool 100 (e.g., power tool). The powered hammer tool 100 is, for example, an in-line demolition hammer including a housing 105, a handle 110, an output drive device or mechanism 115, and a battery pack receiving portion 120. The powered hammer tool 100 further includes a motor, such as motor 305 (FIG. 3) within the housing 105 and having a rotor shaft. The rotor shaft is coupled via a gear mechanism to the output drive or mechanism 115 to drive a tool bit of the powered hammer tool 100. The housing 105 and the handle 110 may be composed of a durable, lightweight plastic or composite material. The handle 110 is used to grip the powered hammer tool and may include a trigger and/or power switch to turn on and operate the powered hammer tool 100. The drive device or mechanism 115 may include or receive an output spindle. In some embodiments, the drive device or mechanism 115 includes an oscillating, spring-driven output (e.g., for rotary hammers, concrete breakers, or the like).

The battery pack receiving portion 120 is configured to receive and couple to a battery pack 200 that provides operating power to the powered hammer tool 100. The battery pack receiving portion 120 includes a connecting structure to engage a mechanism that secures the battery pack 200 and a terminal block to electrically connect the battery pack 200 to the powered hammer tool 100.

FIG. 2A illustrates an in-line demolition hammer, however, the powered hammer tool 100 may include demolition hammers, breakers, rotary hammers, and the like. While the embodiments herein are described with a breaker or a powered hammer tool, they may be equally applicable to other power tools, including drills, circular saws, jig saws, band saws, reciprocating saws, screwdrivers, angle grinders, straight grinders, hammers, multi-tools, impact wrenches, rotary hammers, impact drivers, angle drills, powered ratchets, powered torque wrenches, hydraulic pulse tools, hydraulic tensioning tools, lock bolt installation tools, reaction arm tools, riveting tools, nailers, staplers, TC bolt guns, portable power sources that convert battery power to AC output using an inverter, and the like.

FIG. 2B illustrates a battery pack 200 according to some embodiments. The battery pack 200 is a power tool battery pack that is generally used to power a power tool, such as the powered hammer tool 100. The battery pack 200 includes a battery housing 210 and an interface portion 220 for connecting the battery pack 200 to a device (e.g., the powered hammer tool 100). In some embodiments, the battery pack 200 includes lithium-ion battery cells. In other embodiments, the battery pack 200 may be of a different chemistry, for example, nickel-cadmium, nickel-metal hydride, and the like. In the illustrated embodiment, the battery pack 200 is a 72-Volt nominal voltage battery pack. In other embodiments, the output voltage level of the battery pack 200 may be different. For example, the battery pack 200 can be a 4-volt battery pack, an 18-volt battery pack, a 28-volt battery pack, a 36-volt battery pack, a 72-volt battery pack, or another voltage (voltage here may refer to nominal voltage). The battery pack 200 may also have various capacities (e.g., 3, 4, 5, 6, 8, or 12 ampere-hours).

The battery pack 200 also includes terminals to connect to the powered hammer tool 100. The terminals for the battery pack 200 include a positive and a negative terminal to provide power to and from the battery pack 200. In some embodiments, the battery pack 200 also includes data terminals to communicate with the powered hammer tool 100. For example, the battery pack 200 may include a microcontroller to monitor one or more characteristics of the battery pack 200, and the data terminals may communicate with the powered hammer tool 100 regarding the monitored characteristics.

FIG. 3 is a block diagram of a control system of the breaker 10 or the powered hammer tool 100, according to some embodiments. The control system includes a controller 300 (e.g., an electronic controller). The controller 300 is electrically and/or communicatively connected to a variety of modules or components of the powered hammer tool 100. For example, the controller 300 is electrically connected to a power source 310 (e.g., battery pack 26, 200), a trigger switch 315 (connected to a trigger 320—e.g., a variable speed trigger), one or more sensors 325, one or more indicators 330, a user input module 335, a power input 340, and a power switching network 350. The controller 300 includes combinations of hardware and software that are operable, among other things, to control the operation of the powered hammer tool 100, monitor the operation of the powered hammer tool 100 using, for example, the one or more sensors 325, activate the one or more indicators 330 (e.g., an LED), and/or the like.

The controller 300 includes a plurality of electrical and electronic components that provide power, operational control, and protection to the components and modules within the controller 300 and/or the powered hammer tool 100. For example, the controller 300 includes, among other things, a processing unit 355 (e.g., a microcontroller or another suitable programmable device), a memory 360, input units 365, and output units 370. The processing unit 355 includes, among other things, a control unit 375, an ALU 380, and a plurality of registers 385 (shown as a group of registers in FIG. 3) and is implemented using a known computer architecture (e.g., a modified Harvard architecture, a von Neumann architecture, etc.). The processing unit 355, the memory 360, the input units 365, and the output units 370, as well as the various modules or circuits connected to the controller 300, are connected by one or more control and/or data buses (e.g., a common bus 390). The control and/or data buses are shown generally in FIG. 3 for illustrative purposes. The use of one or more control and/or data buses for the interconnection between and communication among the various modules, circuits, and components would be known to a person skilled in the art.

The memory 360 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 355 is connected to the memory 360 and executes software instructions that are capable of being stored in a RAM of the memory 360 (e.g., during execution), a ROM of the memory 360 (e.g., on a generally permanent basis), or another non-transitory computer readable medium such as another memory or a disc. Software included in the implementation of the powered hammer tool 100 can be stored in the memory 360 of the controller 300. The software includes, for example, firmware, one or more applications, program data, filters, rules, one or more program modules, and other executable instructions. The controller 300 is configured to retrieve from the memory 360 and execute, among other things, instructions related to the control processes and methods described herein. In other constructions, the controller 300 includes additional, fewer, or different components.

In some embodiments, the powered hammer tool 100 includes a battery pack interface (not shown) including a combination of mechanical components (e.g., rails, grooves, latches, etc.) and electrical components (e.g., one or more terminals) configured to and operable for interfacing (e.g., mechanically, electrically, and communicatively connecting) the powered hammer tool 100 with the power source 310 (e.g., the battery pack 26, 200). For example, power provided by the battery pack 200 to the powered hammer tool 100 is provided through the battery pack interface to the power input 340. The power input 340 includes combinations of active and passive components to regulate or control the power received from the battery pack 200 prior to power being provided to the controller 300. The battery pack interface also supplies power via the power input 340 to the power switching network 350 to provide power to the motor 305. The battery pack interface also includes, for example, a communication line 395 for providing a communication line or link between the controller 300 and the battery pack 200.

The one or more indicators 330 include, for example, one or more light-emitting diodes (“LEDs”). The one or more indicators 330 can be configured to display conditions of, or information associated with, the powered hammer tool 100. For example, the one or more indicators 330 are configured to indicate measured electrical characteristics of the powered hammer tool 100, the status of the powered hammer tool 100, etc. The user input module 335 is operably coupled to the controller 300 to, for example, select a forward mode of operation or a reverse mode of operation, a torque and/or speed setting for the powered hammer tool 100 (e.g., using torque and/or speed switches), etc. In some embodiments, the user input module 335 includes a combination of digital and analog input or output devices required to achieve a desired level of operation for the powered hammer tool 100, such as one or more knobs, one or more dials, one or more switches, one or more buttons, etc. Although illustrated separately, the trigger switch 315 and/or the trigger 320 may be a part of the user input module 335.

The power switching network 350 provides operating power to the motor 305 based on control signals from a motor controller, such as the controller 300. The power switching network 350 includes a plurality of electronic switches (e.g., FETs, bipolar junction transistors, and the like) connected to form a network that controls the activation of the motor 305 based on pulse-width modulated (PWM) signals. The power switching network 350 may be implemented as an inverter (e.g., a three-phase bridge, a two-phase bridge—e.g., an H-bridge, or the like). For instance, the power switching network 350 may receive PWM signals from the controller 300 to drive the motor 305. In some embodiments, such as in the breaker 10, the inverter includes a high-frequency Gallium Nitride (GaN) inverter. Generally, when the trigger 320 is depressed, electrical current is supplied from the power source 310 to the motor 305 via the power switching network 350. When the trigger 320 is not depressed, electrical current is not supplied from the power source 310 to the motor 305. For example, a trigger pull sensor senses the amount that the trigger 320 is pulled. In some examples, the output of the power switching network 350 is provided to an AC outlet to power an AC device.

The motor 305 may be energized based on a state of the trigger 320. Generally, when the trigger 320 is activated, the motor 305 is energized, and when the trigger 320 is deactivated, the motor 305 is de-energized. In the illustrated embodiment, the trigger 320 may be biased (e.g., with a biasing member such as a spring) such that the trigger 320 moves in a second direction away from the handle of the powered hammer tool 100 when the trigger 320 is released by the user. In some embodiments, the controller 300 determines a shutdown condition of the powered hammer tool 100 based on the trigger pull sensor. For example, the controller 300 may determine that the powered hammer tool 100 is no longer being operated based on a lack of input from the trigger pull sensor and/or a release of the trigger pull sensor for a predetermined amount of time. In some examples, the trigger 320 is a variable-speed trigger such that the trigger switch 315 provides a signal to the controller 300 corresponding to the amount of trigger pull (e.g., the distance to which the trigger is pulled). This signal from the trigger switch 315 may be generated using, for example, a potentiometer, an inductive sensor, or the like, and provides a speed command (e.g., as a percentage of maximum speed).

The power switching network 350 is electrically connected to the motor 305. In some embodiments, the motor 305 is a brushless DC (BLDC) motor. In some embodiments, the motor 305 is a permanent magnetic synchronous motor (PMSM). In some embodiments, the power source 310 is a battery pack, such as the battery pack 26, 200.

In some embodiments, the controller 300 stores a machine learning model 345 separately or within the memory 360. The machine learning model 345 may be implemented using a convolutional neural network or a deep neural network implemented within the processing unit 355 or a separate neural processor.

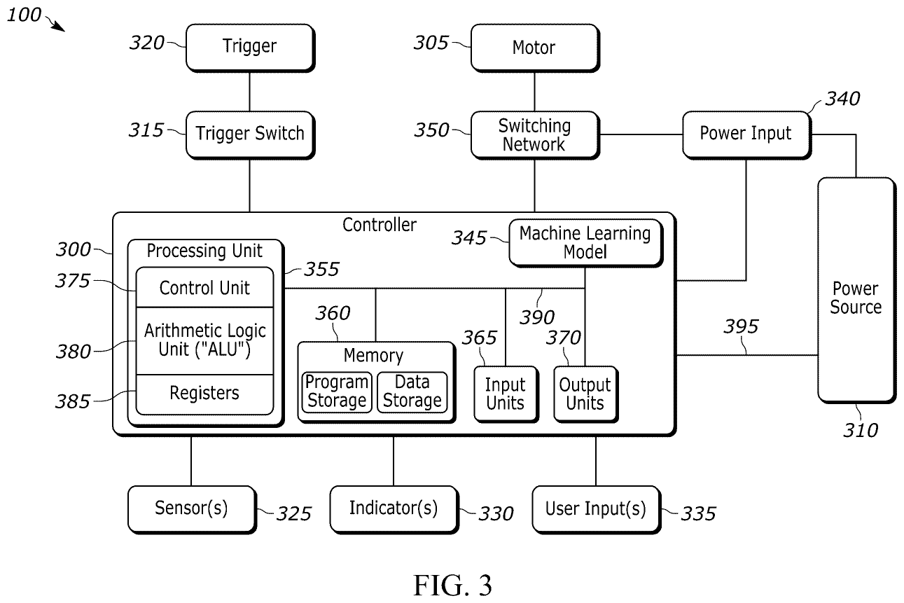

FIG. 4 is a flowchart illustrating an example method 400 for operating the powered hammer tool 100. The method 400 may be implemented using the controller 300. In the example illustrated, the method 400 includes determining a temperature of the powered hammer tool 100 (at block 405). The controller 300 may detect a temperature of electronic components within the powered hammer tool 100 using a temperature sensor (e.g., one or more sensors 325). In one example, the temperature is the temperature of an electronics heatsink of the powered hammer tool 100. The electronics heatsink may be used to cool the FETs of the power switching network 350 or other components of the powered hammer tool 100. The temperature sensor may be provided adjacent the electronics heatsink to determine the temperature of the electronics heatsink or the ambient temperature around the electronics heatsink. In some examples, the controller 300 may estimate the temperature using other methods or sensors.

The method 400 includes determining at least one operating parameter of the powered hammer tool 100 (at block 410). In one example, the controller 300 determines the motor speed and the motor power. The motor speed may be determined using a position sensor (e.g., one or more sensors 325). The position sensor is, for example, a Hall position sensor provided with the motor 305, and the controller 300 determines the motor speed based on a change in the motor position (e.g., mechanical rotor angle) detected by the Hall position sensor over time. In some examples, motor position may be detected using back electro-motive force (BEMF) sensors. The motor power may be determined using a torque sensor (e.g., one or more sensors 325) or based on a determined motor current and a voltage at the motor, at a DC bus, or the input voltage from the battery pack 200. The motor current may be determined using one or more current sensors (e.g., one or more sensors 325) provided on a current path between the power source 310 and the motor 305. The voltage may be detected using a voltage sensor (e.g., one or more sensors 325). In some embodiments, the voltage is the input battery voltage and is communicated to the controller 300 from a controller of the battery pack 200. In other embodiments, the at least one operating parameter may include a current, an accumulated runtime, or other parameters.

The method 400 includes determining an operating state of the powered hammer tool 100 based on the temperature and the at least one operating parameter (at block 415). The operating state indicates whether the powered hammer tool 100 is in a loaded state or an unloaded state. In one example, coefficients (e.g., a first coefficient and a second coefficient) and an offset are stored in the memory 360 corresponding to the determined operating state. The controller 300 determines a linear sum of at least a product of a first coefficient and the at least one parameter, a product of a second coefficient and the temperature, and the offset. For example, the linear sum may be determined based on the coefficients (m1, m2, m4), the motor speed, and the motor power, and an offset (b) as below:

$$\text{?} ( L ) = ( m 1 \times power + ( m 2 \times speed + ( m 3 \times \text{?} b$$

$$\text{?} \text{indicates text missing or illegible when filed}$$

The coefficients include a first coefficient m1 for motor power, a second coefficient m2 for motor speed, and a third coefficient m3 for temperature. Using this example equation, the controller 300 determines a predictor based on the linear sum and compares the predictor to an operating state threshold. For example, the predictor is determined as below:

$$\text{?} = \frac{1}{( 1 + {e}^{- L} )}$$

$$\text{?} \text{indicates text missing or illegible when filed}$$

The predictor is determined as the inverse of 1 plus an exponential function of a negative linear sum. The predictor has a value between 0 and 1. The predictor is then compared (e.g., by the controller 300) to the operating state threshold. In one example, the operating state threshold is 0.5. The powered hammer tool 100 is considered to be in an operating state of a loaded state when the predictor is greater than or equal to, or greater than 0.5. The powered hammer tool 100 is considered to be in an operating state of an unloaded state when the predictor is less than or equal to, or less than 0.5. In some examples, additional parameters may also be used in determining the load state. One example additional parameter includes accumulated run time or accumulated loaded time.

The method 400 includes driving the motor 305 at a first speed (at block 425) in response to the powered hammer tool 100 being in the loaded state. The method 400 includes driving the motor 305 at a second speed (at block 430) in response to the powered hammer tool 100 being in the unloaded state. The first speed is greater than the second speed. In one example, the first speed is a high constant speed and the second speed is a low constant speed. In another example, the second speed is a low constant speed and the first speed is a speed corresponding to the operation of the trigger 320. In yet another example, the first speed is a speed corresponding to the operation of the trigger 320 and the second speed is a fraction of the first speed at the operation level of the trigger 320. Other examples may include a different combination of constant speeds and variable speeds for the first speed and the second speed.

In some examples, the load-based speed control, for example, as described with blocks 415-430, may only be performed in certain modes and not performed in other modes. Taking the example of a rotary hammer, the load-based speed control may only be performed in a chipping/hammering mode and/or a rotary hammer mode and not in a drilling only mode. The controller 300 may receive the input of a first mode (e.g., drilling only mode). In response to receiving the selection of the first mode, the controller 300 drives the motor at a selected speed (e.g., a third speed) regardless of the operating state of the powered hammer tool 100. The controller 300 may receive the selection of the modes (including the constant mode) using an actuator (e.g., a button) on the powered hammer tool 100, via an application running on a connected smart device (e.g., smartphone, tablet, etc.), or via other means. The selected speed may be a constant speed (e.g., constant high speed) or a speed corresponding to the operation amount of the trigger 320. In some examples, the selected speed is the first speed.

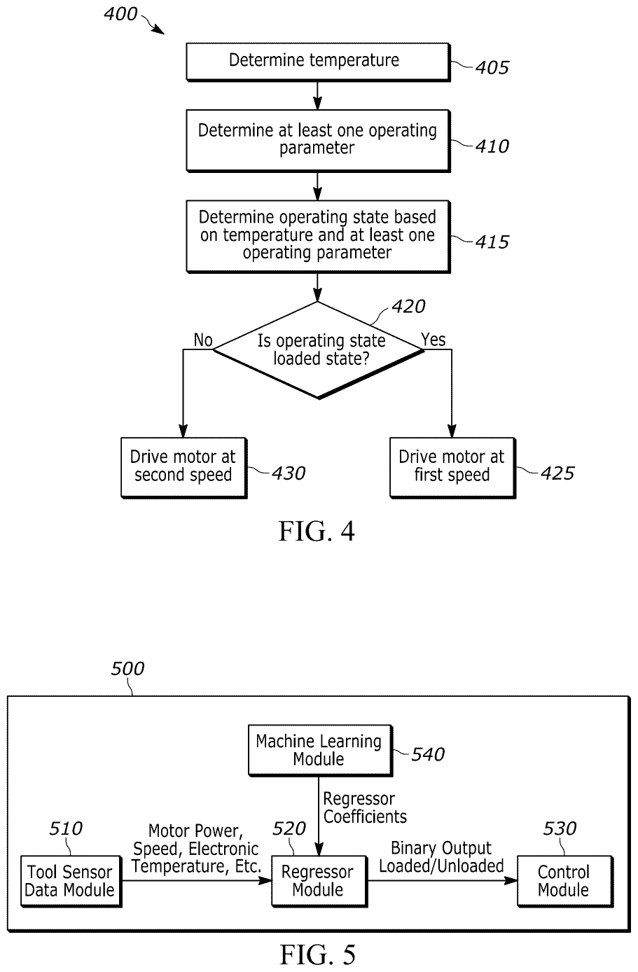

FIG. 5 illustrates a simplified block diagram of tool electronics 500 for operating the powered hammer tool 100 as described with respect to FIG. 4. The tool electronics 500 may be implemented by the controller 300 and other components as shown in FIG. 3. The tool electronics 500 includes a tool sensor data module 510, a regressor module 520, a control module 530, and a machine learning module 540. The tool sensor data module 510 may determine and aggregate the at least one operating parameter and temperature data from the one or more sensors 325. The tool sensor data module 510 provides the at least one operating parameter and temperature data to the regressor module 520. The regressor module 520 uses the stored coefficients, the offset, and the operating state threshold to provide a binary output (i.e., loaded or unloaded) to the control module 530. The control module 530 controls the speed as described with respect to FIG. 4, or a load state counter as further described below.

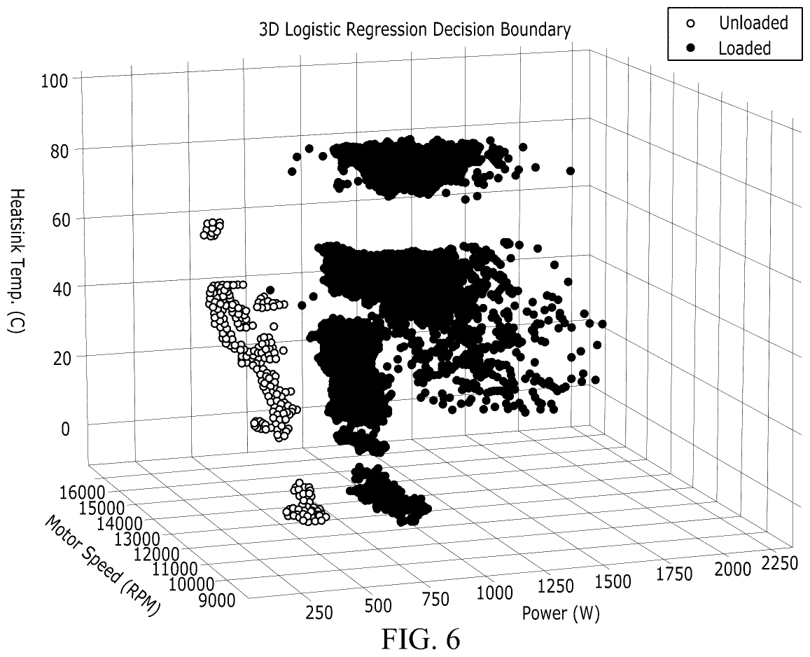

The coefficients, the offset, and/or the operating state threshold may be determined using the machine learning module 540. In the example illustrated, the machine learning module is provided as part of the powered hammer tool 100. However, the machine learning module may be separate from the powered hammer tool 100 and used by the manufacturer to pre-determine the coefficients, offset, and/or the operating state threshold. The powered hammer tool 100 may be tested under real-world conditions at different environmental and operating temperatures, speeds, and loading. The test results may be provided as training data to the machine learning module 540, e.g., using a supervised or unsupervised learning method. The machine learning module 540 may then provide the coefficients, the offset, and/or the operating state threshold as the output to the regressor module 520. FIG. 6 illustrates an example graph 600 showing the training data with the loaded state and unloaded state differentiated. The inputs may include motor speed, motor power, electronics heatsink temperature. The machine learning module 540 outputs the coefficients, the offset, and/or the operating state threshold based on the training data. In some embodiments where the machine learning module 540 is part of the powered hammer tool 100, the machine learning module 540 may periodically update the coefficients, the offset, and/or the operating state threshold based on new data observed and recorded during on-field operation of the powered hammer tool 100.

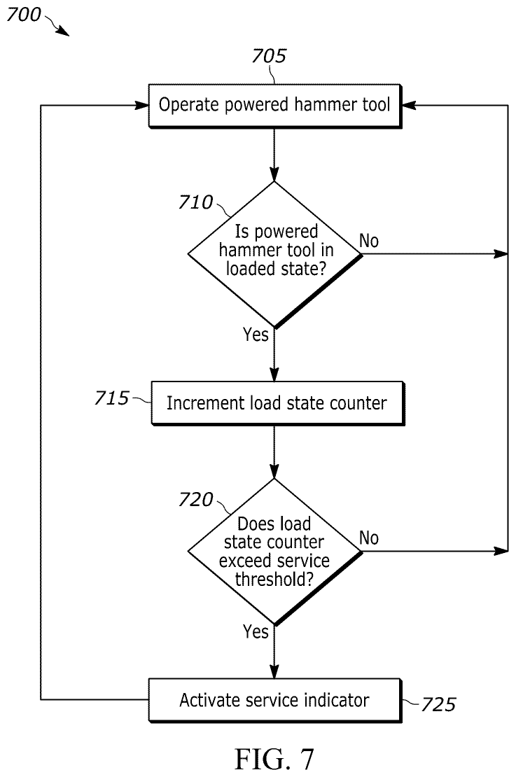

FIG. 7 is a flowchart illustrating an example method 700 for operating the powered hammer tool 100. The method 700 may be implemented using the controller 300. The method 700 includes operating the powered hammer tool 100 (at block 705). The powered hammer tool 100 may be operated as described above with respect to FIG. 4. The method 700 includes determining whether the powered hammer tool 100 is in a loaded state (at block 710). The controller 300 may determine the operating state similarly as discussed above with respect to method 400.

The method 700 includes incrementing a load state counter (at block 715) in response to the powered hammer tool 100 being in the loaded state. The controller 300 may track the accumulated runtime of the powered hammer tool 100 for service requirements. Typically, the accumulated runtime is determined by incrementing a counter (e.g., recording the amount of time) for which the powered hammer tool 100 is on, regardless of whether the powered hammer tool 100 is in the unloaded state or the loaded state. However, this may result in frequent activation of service indicators even though the powered hammer tool 100 has not experienced sufficient use for service. To avoid frequent service indicator activations, the controller 300 may increment the load state counter only when the powered hammer tool 100 is loaded. The controller 300 starts the load state counter or otherwise accumulates the runtime when the controller 300 determines that the powered hammer tool 100 is in the loaded state. In some examples, the controller 300 stops the load state counter when the powered hammer tool 100 returns to the unloaded state and/or when the powered hammer tool 100 is stopped.

The method 700 includes determining whether the load state counter exceeds a service threshold (at block 720). The controller 300 compares the load state counter to a predetermined service threshold. The predetermined threshold may be specific to the powered hammer tool 100 being operated. The controller 300 may determine the predetermined threshold using a lookup table. In response to the load state counter not exceeding the predetermined threshold, the controller 300 continues operating the powered hammer tool 100. The method 700 may include activating (via the controller 300) a service indicator (at block 725) in response to the load state counter exceeding the service threshold. The controller 300 activates the service indicator (e.g., one or more indicators 330) on the housing 105 and/or transmits a service indicator to a connected external device (e.g., smartphone). Activating the service indicator may include turning on an LED, activating a sound, or a combination thereof.

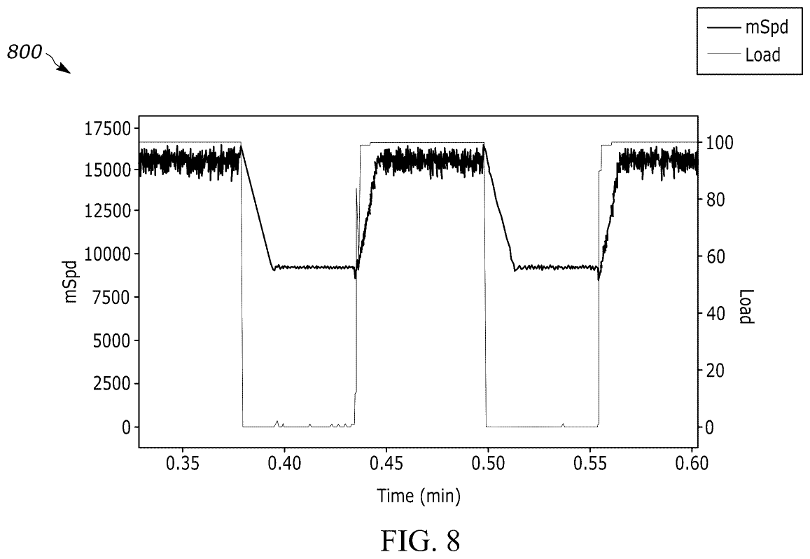

FIG. 8 is a graph 800 illustrating variation in the motor speed and operating state based on the operation of the powered hammer tool 100 according to the method 400. The controller 300 determines the operating state of the powered hammer tool 100 and drives the motor 305 accordingly.

The techniques described herein improve the runtime of power tools. For example, runtime of power tools having an oscillating, spring-driven output such as rotary hammers and concrete breakers can be improved by the methods described above. The predicted load may be determined with the help of a machine-learned based technique (e.g., logistic regressor example provided in FIG. 5). Additionally, the method 700 improves service interval tracking with improved separation of loaded and unloaded runtime on the power tool. The load sensing technique described with respect to FIGS. 4-6 would further resolve unexpected tool behavior in tool wear scenarios (e.g., temperature, speed, or power changes or surges).

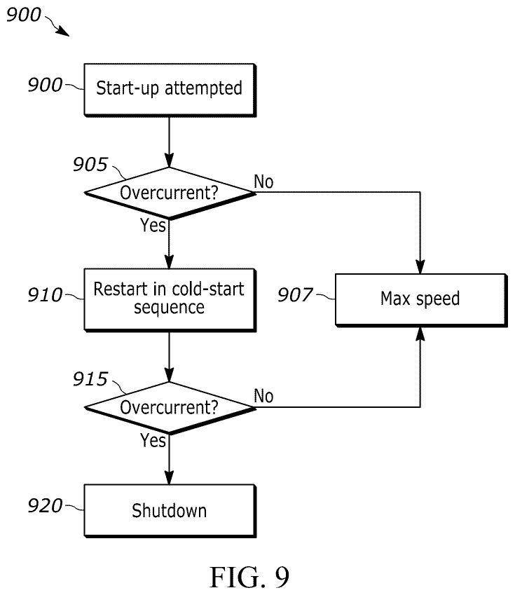

FIG. 9 illustrates a method 900 for controlling the breaker 10, according to some embodiments. The method 900 may be performed by the controller 300 included in the breaker. As illustrated in FIG. 9, when the trigger (e.g., trigger 320) of the breaker 10 is depressed, electrical current is supplied from the power source 310 to the motor 305 via the power switching network 350 as part of a normal start-up operation (a “first start-up operation”) (block 905). The normal start-up operation controls motor operation (e.g., through supply of power to the motor 305) according to a first start-up profile having a first start-up or ramp rate applied over a first time period. The first start-up rate may be a linear rate, such that motor speed is increased at a linear rate over the first time period to reach an ending speed (e.g., a target speed) associated with the start-up operation. In other embodiments, the first start-up rate is parabolic. In some embodiments, the ending speed is a maximum operating speed of the breaker 10. However, in other embodiments, the ending speed may be a speed less than the maximum operating speed.

The normal start-up operation may fail when the torque exerted on the motor 305 is too high. As noted above, in some examples, a high torque may be exerted on the motor 305 when the breaker 10 is operated in cold temperature environments (e.g., temperatures below −10° C.). In such environments, the cold temperature causes the lubricant surrounding the percussion mechanism 22 of the breaker 10 to be more viscous. An increase in the lubricant viscosity, in turn, requires higher torque to operate the percussion mechanism 22, which means a high torque is exerted on the motor 305 (as compared to a torque exerted during a start-up in a warmer environment). Such a high torque can lead to peak currents that trip an overcurrent protection component (which may be a hardware and/or software component of the tool that may, for example, stop power supply to the motor such as by opening one or more switches in the power switching network 350), which causes the motor 305 to stop (e.g., causes the breaker 10 to shut down) during the normal start-up operation before the motor 305 reaches the ending operating speed (e.g., cause a dead trigger pull).

As illustrated in FIG. 9, in response to the overcurrent protection component not being tripped during the normal start-up operation, the normal start-up operation continues until the ending speed (e.g., maximum speed) defined by the first start-up profile is reached (at block 907).

Alternatively, in response to the overcurrent protection component being tripped during the normal start-up operation (at block 905), the controller 300 initiates a cold start-up operation (e.g., a “second start-up operation”) according to a second start-up profile, wherein the second start-up profile differs from the first start-up profile (at block 910). For example, the second start-up profile has a second start-up rate and a second time period, wherein at least one of the second start-up rate and the second time period differs from the first start-up rate and the first time period of the first start-up profile. In some embodiments, the second start-up profile may increase motor speed to an ending speed different than the ending speed used in the first start-up profile (e.g., in cold environments, the controller 300 may run the motor at a lower “maximum” speed).

Accordingly, the cold start-up operation is configured to, among other things, warm up the lubricant in the motor 305 when operating the breaker 10 in cold temperatures. It should be understood that, in some embodiments, the controller 300 initiates the cold start-up operation in response to detecting triggering events other than the overcurrent event or may initiate the cold start-up operation in response to detecting the overcurrent event in combination with other events (e.g., a detected temperature, a detected viscosity of the lubricant, or the like) and/or detecting the overcurrent event or another event a predetermined number of times (e.g., within a threshold time period).

During the cold start-up operation, the controller 300 initiates a motor control (via the second start-up profile) that is different than the motor control initiated during the normal start-up operation (via the first start-up profile). In some embodiments, the controller 300 controls the power switching network 350 (e.g., adjusts the duty cycle) according to a second start-up profile to control a speed of the motor. In such a configuration, the controller 300 may exit the cold start-up operation in response to the duty cycle reaching a predetermined level (e.g., 99%) associated with the motor reaching the ending speed.

In some embodiments, the second start-up profile includes a linear ramp rate (i.e., includes a “linear profile”), such that a speed of the motor 305 is increased at a linear rate to an ending speed over the second time period. In the linear profile, the linear rate differs from the first start-up rate of the first start-up profile (applied during the normal start-up operation), which may also be linear. For example, the linear profile applied during the cold start-up operation may define a linear rate that is less than a linear rate applied during the normal start-up operation. Accordingly, when the linear profile is applied, it takes longer for the ending speed to be reached during the cold start-up operation than as compared to the normal start-up operation since, at each time interval, the motor speed is increased less in the cold start-up operation. This increased time period associated with the second start-up profile (which may be approximately 20 seconds as compared to 1 second used during the normal start-up operation) allows the motor speed to increase slower but still at a linear rate, which gives the lubricant more time to warm up and reduces the risk of an overcurrent event occurring due to high motor torque. Therefore, given this difference in duration, the slope of the linear rate during the cold-start operation is less than the slope of the linear rate during the normal start-up operation.

As an alternative to applying a linear profile during the cold start-up operation, in some embodiments, the controller 300 controls the power switching network 350 to drive the speed of the motor 305 according to a second start-up profile that includes a parabolic ramp rate (i.e., includes a “parabolic profile”), such that a speed of the motor is increased at a parabolic rate to an ending speed over the second time period. In such a parabolic profile, motor speed increases at a parabolic rate wherein the rate of change in the motor speed increases the longer the breaker 10 is operated in the cold start-up operation until the ending speed is reached. Accordingly, the rate of change of the motor speed in the parabolic profile may differ from the rate of change of the motor speed in the first start-up profile applied during the normal start-up operation, which, as noted above, may include a linear rate of change. Also, in some embodiments, the second time period in the parabolic profile may also be different than the first time period used in the normal start-up operation.

As an alternative to the linear and parabolic profiles, in some embodiments, the controller 300 is configured to control the switching network to drive the speed of the motor 305 according to a second start-up profile that includes an intermediary-speed warm-up (i.e., an intermediary-speed profile), wherein motor speed is initially increased to an intermediary speed (e.g., a speed less than the ending speed) or an initial term period, held constant at the intermediary speed for a hold time period, and, thereafter, increased to the ending speed or an ending time period. As noted, the intermediary speed is less than the ending speed and, in some embodiments, represents a fraction of the ending operating speed (e.g., 10%, 20%, 30%, 40%, 50%, 60%, or 75%). In some embodiments, the speed increases during the initial and ending time periods are applied according to a linear rate or a parabolic rate and, in some embodiments, a different rate may be used in the initial time period as compared to the ending time period. As compared to the first time period used during the normal start-up operation, the total time period in the intermediary speed-profile (i.e., the total of the initial time period, hold time period, and ending time period) may be longer. It should also be understood that the intermediary-speed profile may include a plurality of hold time periods where different intermediary speeds are held before the speed is increased. Such a multiple speed start-up again allows the lubricant to warm up during the start-up operation to prevent overcurrent or other failures and, ultimately, allows the breaker 10 to start-up without failure.

It should be understood that the particular start-up profile applied as the second start-up profile for the cold-start operation may be preprogrammed into a power tool. Alternatively, the controller 300 may be configured to select, from a set of available profiles, a profile to apply during the cold-start operation based on one or more parameters of the power tool or operating conditions of the same. For example, the controller 300 may select a profile based on a type of the power tool, a type of power source used with the power tool, a number of detected overcurrent or other failures, a detected temperature, a motor speed when the overcurrent event occurred, a user-selected setting, or a combination thereof. Also, one or more of the linear, parabolic, and intermediary-speed profiles as described herein may be combined in various ways. For example, as noted, portions of the linear profile may be included in the intermediary-speed profile to control speed increases. Alternatively, portions of the parabolic profile may be included in the intermediary-speed profile to control speed increases. Furthermore, all three profiles may be combined by, for example, applying an initial parabolic rate increase before holding the motor speed at the intermediary speed, and, thereafter, increasing the speed to the maximum speed at a linear rate (or vice versa). Similarly, the linear and parabolic profiles may be combined to define a profile that includes both a period when a linear rate is used and a period when a parabolic rate is used. Furthermore, one or more aspects of the second start-up profile may be dynamic, such that the parameter is set based on current operating conditions. For example, the ramp rate(s), time period(s), intermediary speed(s), or a combination thereof may be set by the controller 300 based on a detected temperature, the motor speed when the overcurrent event occurred, a measured torque before or after initiation of the cold start-up operation, or the like. Thus, the described and illustrated profiles are provided as examples and should not be construed as being limiting.

As illustrated in FIG. 9, in response to an overcurrent event occurring during the cold start-up operation (at block 915), the controller 300 shuts down the breaker 10 (i.e., the motor 305) by, for example, controlling the power switching network 350 to disconnect the motor 305 from the power source 310 (at block 920). Alternatively, when no overcurrent event (or other failure) is detected during the cold start-up operation, the cold start-up operation continues until the ending speed (e.g., a maximum speed) defined by the second start-up profile is reached (at block 925).

It should be understood that, in some embodiments, during a cold start-up operation, the controller 300 may be configured to apply a start-up profile in a closed-loop torque control. In such an embodiment, the controller 300 prevents an overcurrent from tripping by automatically reducing current draw during the cold start-up operation based on a detected motor torque (or other detected motor conditions). This embodiment may be implemented using a high-frequency GaN inverter. Similarly, in some embodiments, such a closed-loop torque control may be applied during the normal start-up operation (e.g., when applying the first start-up profile) based on a detected temperature or other operating condition. Accordingly, the closed-loop torque control may be applied as part of the normal start-up operation to automatically adapt the first start-up profile (e.g., without the need for switching to a cold start-up operation with a different start-up profile).

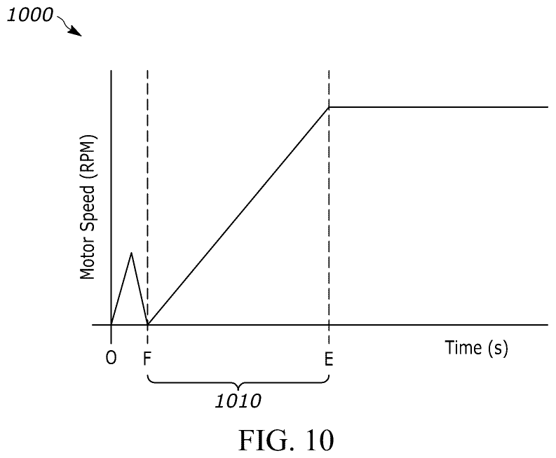

FIG. 10 is a graph 1000 illustrating an example of variation in motor speed of the breaker 10 during the cold start-up operation when a linear profile is applied. In this example, at time 0 on the graph (represented by the x-axis), the controller 300 initiates the normal start-up operation according to the first start-up profile. During the normal start-up operation, the operation fails, such as, for example, due to the tripping of the overcurrent protection component during the normal start-up operation. In response to detecting such an overcurrent event (e.g., at time F), the controller 300 initiates the cold start-up operation according to the second start-up profile and, in particular, according to a linear profile as described above. In particular, as illustrated in the graph 1000, during the time period 1010, the motor speed increases at a linear rate until an ending speed (e.g., a maximum speed) is reached at time E.

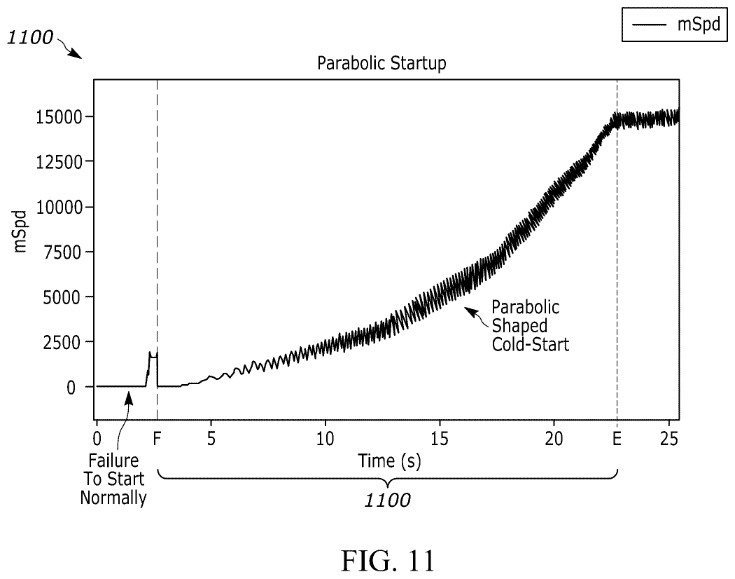

FIG. 11 is a graph 1100 illustrating an example of variation in motor speed of the breaker 10 during the cold start-up operation when a parabolic profile is applied. In this example, at time 0 on the graph (represented by the x-axis), the controller 300 initiates the normal start-up operation according to the first start-up profile. During the normal start-up operation, the operation fails, such as, for example, due to the tripping of the overcurrent protection component during the normal start-up operation. In response to detecting such an overcurrent event (e.g., at time F), the controller 300 initiates the cold start-up operation according to the second start-up profile and, in particular, according to a parabolic profile as described above. In particular, as illustrated in the graph 1100, during the second time period 1110, the motor speed increases at a parabolic rate until an ending speed (e.g., a maximum speed) is reached at time E.

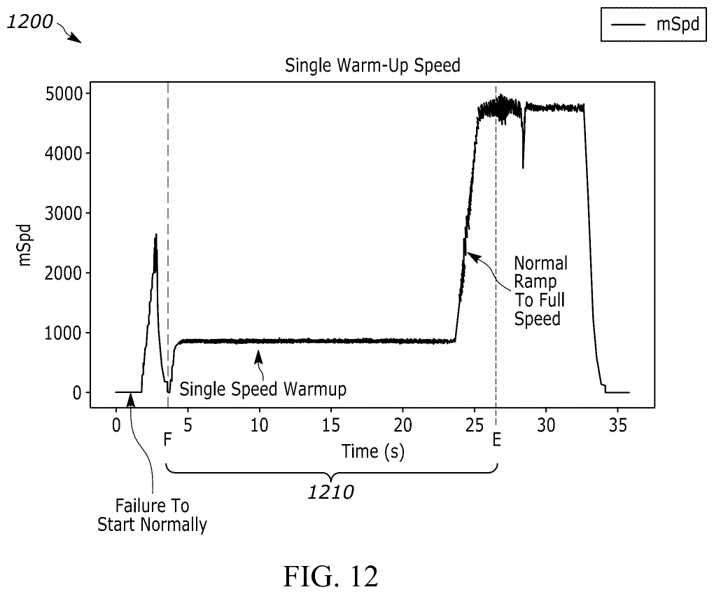

FIG. 12 is a graph 1200 illustrating an example of variation in motor speed of the breaker 10 during the cold start-up operation when the controller 300, according to the second start-up profile, and, in particular, according to the intermediary-speed profile. With this profile, the controller 300 increases the speed of the motor to an intermediary speed before increasing the speed of the motor from the intermediary speed to the ending speed. The intermediary speed is lower than the ending speed. In this example, at time 0 on the graph (represented by the x-axis), the controller 300 initiates the normal start-up operation according to the first start-up profile. During the normal start-up operation, the operation fails, such as, for example, due to the tripping of the overcurrent protection component during the normal start-up operation. In response to detecting such an overcurrent event (e.g., at time F), the controller 300 initiates the cold start-up operation according to the second start-up profile, where the controller increases the speed of the motor to the intermediary speed before increasing the speed of the motor to the ending speed. In particular, as illustrated in the graph 1200, the motor speed increases at a linear rate to the intermediary motor speed, starting at time F, over an “initial” time period, maintains the motor speed at the intermediary speed for a “holding” time period, and then increases the motor speed at a linear rate over an “ending” time period until an ending speed (e.g., a maximum speed) is reached at time E. A total of the initial time period, the holding time period, and the ending time period (represented as time period 1210 in FIG. 12) may be longer than the first time period used during the normal start-up operation, and, in some embodiments, the holding time period is longer than the first time period.

Although the methods and control profiles and operations may be described herein with respect to a particular power tool (e.g., the powered hammer tool 100 or the breaker 10), it should be understood that the methods and control profiles and operations may be used with various types of power tools and are not limited to the example tool used in the description. For example, the cold start-up operation is described herein with respect to the breaker 10, but may also be used with the powered hammer tool 100, or other types of tools.

Thus, embodiments described herein provide, among other things, power tools and cold start-up operations for the same. Various features and advantages are set forth in the following claims.

What is claimed is:

1. A powered hammer tool comprising:
a housing;
a motor within the housing; and
an electronic controller electronically connected to the motor and configured to:
determine a temperature of the powered hammer tool;
determine at least one operating parameter of the powered hammer tool;
determine an operating state of the powered hammer tool based on the temperature and the at least one operating parameter, the operating state indicating whether the powered hammer tool is in a loaded state or an unloaded state;
drive the motor at a first speed in response to the powered hammer tool being in the loaded state; and
drive the motor at a second speed in response to the powered hammer tool being in the unloaded state, wherein the first speed is greater than the second speed.

2. The powered hammer tool of claim 1, wherein the operating state is at least one selected from a group consisting of a motor speed and a motor power, and wherein the electronic controller is further configured to determine the operating state further based on an accumulated runtime of the powered hammer tool.

3. The powered hammer tool of claim 1, further comprising a memory configured to store a first coefficient for the at least one operating parameter, a second coefficient for the temperature, and an offset, wherein the electronic controller is further configured to:
determine a linear sum of at least a product of the first coefficient and the at least one operating parameter, a product of the second coefficient and the temperature, and the offset;
determine a predictor based on the linear sum;
compare the predictor to an operating state threshold, wherein the operating state is determined based on a relationship between the predictor and the operating state threshold; and
update, using a machine learning model, the first coefficient, the second coefficient, and the offset.

4. The powered hammer tool of claim 1, further comprising a temperature sensor adjacent an electronics heatsink configured to provide an indication of a temperature of the electronics heatsink, wherein the electronic controller is configured to determine the temperature using the temperature sensor, wherein the temperature of the powered hammer tool is the temperature of the electronics heatsink of the powered hammer tool.

5. The powered hammer tool of claim 1, wherein the electronic controller is further configured to:
increment a load state counter in response to the powered hammer tool being in the loaded state;
activate a service indicator in response to the load state counter exceeding a service threshold, and
stop the load state counter in response to the powered hammer tool being in the unloaded state.

6. The powered hammer tool of claim 1, wherein the electronic controller is configured to:
receive a selection of a first mode; and
drive the motor at a selected speed regardless of the operating state of the powered hammer tool in response to the selection of the first mode.

7. A method for operating a powered hammer tool including a motor, the method comprising:
determining, using an electronic controller of the powered hammer tool, a temperature of the powered hammer tool;
determining, using the electronic controller, an operating state of the powered hammer tool based on the temperature and at least one operating parameter, the operating state indicating whether the powered hammer tool is in a loaded state or an unloaded state;
driving, using the electronic controller, the motor at a first speed in response to the powered hammer tool being in the loaded state; and
driving, using the electronic controller, the motor at a second speed in response to the powered hammer tool being in the unloaded state, wherein the first speed is greater than the second speed.

8. The method of claim 7, wherein the operating state is at least one selected from a group consisting of a motor speed and a motor power, and wherein determining the operating state is further based on an accumulated runtime of the powered hammer tool.

9. The method of claim 7, further comprising:
storing, in a memory of the powered hammer tool, a first coefficient for the at least one operating parameter, a second coefficient for the temperature, and an offset;
determining a linear sum of at least a product of the first coefficient and the at least one operating parameter, a product of the second coefficient and the temperature, and the offset;
determining a predictor based on the linear sum;
comparing the predictor to an operating state threshold, wherein the operating state is determined based on a relationship between the predictor and the operating state threshold; and
updating, using a machine learning model, the first coefficient, the second coefficient, and the offset.

10. The method of claim 7, further comprising:
providing, using a temperature sensor adjacent an electronics heatsink, an indication of a temperature of the electronics heatsink; and
determining the temperature based on the indication,
wherein the temperature of the powered hammer tool is the temperature of the electronics heatsink of the powered hammer tool.

11. The method of claim 7, further comprising:
incrementing a load state counter in response to the powered hammer tool being in the loaded state;
activating a service indicator in response to the load state counter exceeding a service threshold, and
stopping the load state counter in response to the powered hammer tool being in the unloaded state.

12. The method of claim 7, further comprising:
receiving a selection of a first mode; and
driving the motor at a selected speed regardless of the operating state of the powered hammer tool in response to the selection of the first mode.

13. A breaker comprising:
a housing;
a motor within the housing; and
an electronic controller electronically connected to the motor and configured to:
initiate a first start-up operation of the motor by increasing a speed of the motor according to a first start-up profile, the first start-up profile defining a start-up rate of the motor for reaching an ending speed over a first time period,
detect an overcurrent event during the first start-up operation, and
in response to detecting the overcurrent event, initiate a second start-up operation of the motor according to a second start-up profile, the second start-up profile different than the first start-up profile.

14. The breaker of claim 13, wherein the electronic controller is configured to increase a speed of the motor at a linear rate over a second time period until reaching the ending speed during the second start-up operation, wherein the second time period is longer than the first time period.

15. The breaker of claim 13, wherein the electronic controller is configured to increase a speed of the motor at a parabolic rate over a second time period until reaching the ending speed during the second start-up operation, wherein the second time period is longer than the first time period.

16. The breaker of claim 13, wherein the electronic controller is configured to, during the second start-up operation,
increase a speed of the motor to an intermediary speed during a second time period,
hold the speed of the motor at the intermediary speed for a third time period, and
increases the speed of the motor from the intermediary speed to the ending speed during a fourth time period,
wherein the intermediary speed is lower than the ending speed.

17. The breaker of claim 16, wherein the electronic controller is configured to increase the speed of the motor to the intermediary speed at a linear rate or a parabolic rate during the second time period.

18. The breaker of claim 16, wherein the electronic controller is configured to increase the speed of the motor from the intermediary speed to the ending speed at a linear rate or a parabolic rate during the fourth time period.

19. The breaker of claim 16, wherein a total of the second time period, the third time period, and the fourth time period is longer than the first time period.

20. The breaker of claim 13, wherein the electronic controller is configured to operate the motor during the second start-up operation using a closed-loop control.
